(19) United States
(12) Patent Application Publication
(10) Pub. No.: US 2005/0068379 A1
(43) Pub. Date: Mar. 31, 2005

(54) Droplet discharge head and inkjet recording apparatus

(75) Inventor: Kazuo Sanada, Ashigara-Kami-Gun (JP)

Correspondence Address: BIRCH STEWART KOLASCH & BIRCH, PO BOX 747, FALLS CHURCH, VA, 22040-0747, US

(73) Assignee: Fuji Photo Film Co., Ltd., Minami-Ashigara-shi (JP)

(21) Appl. No.: 10/951,775

(22) Filed: Sep. 29, 2004

(30) Foreign Application Priority Data
Sep. 30, 2003 (JP) 2003-342290

(51) Int. Cl. B41J 2/045

(52) U.S. Cl. 347/70

(57) ABSTRACT

A droplet discharge head comprising: a plurality of nozzles for discharging droplets, a plurality of pressure chambers provided correspondingly to the plurality of nozzles and filled with liquid to be discharged from the nozzles, a vibration plate constituting one of the wall surfaces of the pressure chambers, and a plurality of laminated piezoelectric bodies fixedly joined at independent positions on the vibration plate that correspond to the plurality of pressure chambers; wherein the end portion of the laminated piezoelectric bodies on the side opposite from the joint surface with the vibration plate is formed into an unrestricted end that is displaceable in the direction of pressure applied to the vibration plate by the laminated piezoelectric bodies, and pressure is applied to the liquid inside the pressure chamber via the vibration plate by expansion and contraction displacement produced by the laminated piezoelectric bodies to discharge droplets from the nozzles.

### BACKGROUND OF THE INVENTION

1. Field of the Invention

The present invention relates to a droplet discharge head and an inkjet recording apparatus, and more specifically to a structure for a piezoelectric-drive liquid discharge head for discharging droplets from a nozzle by pressurizing a pressure chamber using a laminated piezoelectric body, and to an ink-jet recording apparatus that uses this structure.

2. Description of the Related Art

An inkjet head for discharging ink using a laminated piezoelectric element is disclosed in Japanese Patent No. 3182831. Representative indicators for expressing the drive characteristics of this type of piezo-drive inkjet head are the generated pressure and displacement volume of the pressure chamber produced by the piezoelectric body. The higher the generated pressure is the higher the controllability is, and this allows high-viscosity liquid to be discharged, or the size of the head to be reduced.

In other words, an aspect is possible in which the efforts to improve the displacement volume are focused on the discharge of high-viscosity liquid, and also possible is an aspect in which the efforts are focused on reducing the head size to obtain a high-density small head by using the fact that a smaller surface area is required for obtaining the required displacement volume.

When aiming to achieve both high speed and high quality using a full-line head having a row of nozzles with a length corresponding to the paper width of the recording medium, minute high-viscosity droplets must be distributable to about 2,400 dpi on the paper surface, for example, in order to reduce the amount of visually detectable nonuniformity and to prevent bleeding and other ejection defects.

If, for example, an attempt were made to bring this about with a conventional piezo-drive inkjet head, a length in the conveyance direction of 25 mm per color would be required, and 150 mm is required for six colors.

However, in an inkjet system, the length of the head in the conveyance direction needs to be kept within a width of about one inch, which is on par with prior art, taking into account that a maintenance system for capping, wiping, and the like must be provided, and that stable functioning, paper conveyance accuracy, and other factors must be ensured.

In order to use functional ink and to prevent bleeding when, for example, high-viscosity liquid that is 10 times more viscous than common ink is discharged without any changes being made to the flow channel configuration of the head, the flow channel resistance must be about 10 times as high, so a simple calculation indicates that the surface area density must be equal to the number of colors multiplied by 10, but this result cannot be achieved in the design range of a conventional piezo-drive inkjet head.

Classifying conventional piezo-drive inkjet head technology gives the following three types of techniques The first is a technique in which unimorph actuators are distributed using printing technology (Japanese Patent No. 3302515). The second is a technique in which a laminated piezoelectric body is disposed on a carrier, and the pressure chamber is pressurized using the free end side (Japanese Patent No. 3182831). The third is a technique (electrode separation system) in which the laminated piezoelectric body is not mechanically isolated, and the drive is isolated with the aid of an electrode pattern wiring in correlation with the pressure chambers (Japanese Patent Application Publication Nos. 2002-166543 and 2001-246744).

The technique related to the above first classification can provide a low-cost head by using printing technology, but it is difficult to form thin piezoelectric bodies with high precision over a large surface area, and to keep the size to about 2 cm or less. Therefore, a plurality of short head units must be linked together to fabricate a full-line head, and it is difficult to form a unitary line head with methods other than the linking method.

The technique related to the above second classification is such that the density in the nozzle row direction becomes a machining limitation for the cutting blade in a manufacturing method in which one side of a relatively large laminated piezoelectric body is used as a common fixed end, and the other end is cut apart. Therefore, when the nozzles are arrayed at a high density, the displacement volume produced by the piezoelectric body must be ensured by setting each of the piezoelectric bodies in a rectangle whose long sides are aligned in the depth direction perpendicular to the cutting direction. In this method, the practical density limit is about 200 dpi, and the horizontal to vertical ratio of the rectangular shape is about 1:10.

The techniques related to the above third classification increases the manufacturing suitability of laminated piezoelectric bodies, but neighboring actuators are mechanically linked together, so there is a considerable of amount of crosstalk (mutual interference between neighboring nozzles), the constraints are significant, and the number of laminated layers must be increased to obtain considerable displacement. These factors lead to a larger head size.

### SUMMARY OF THE INVENTION

The present invention was contrived in view of such circumstances, and an object thereof is to provide a liquid discharge head that prevents crosstalk between nozzles, improves the pressurizing capability of piezoelectric bodies, allows the nozzle density to be increased, makes is possible to discharge high-viscosity liquid, and is suitable for manufacturing; and to an inkjet recording apparatus that uses this liquid discharge head.

The droplet discharge head related to first aspect of the present invention for achieving the above-stated object has a plurality of nozzles for discharging droplets, a plurality of pressure chambers provided correspondingly to the plurality of nozzles and filled with liquid to be discharged from the nozzles, a vibration plate having a single wall surface of the pressure chamber, and a plurality of laminated piezoelectric bodies fixedly joined at independent positions on the vibration plate that correspond to the plurality of pressure chambers; wherein the end portion of the laminated piezoelectric bodies on the side opposite from the joint surface with the vibration plate is formed into an unrestricted end that is displaceable in the direction of pressure applied to the vibration plate by the laminated piezoelectric bodies, and pressure is applied to the liquid inside the pressure chamber via the vibration plate by expansion and contraction displacement produced by the laminated piezoelectric bodies to discharge droplets from the nozzles.

The laminated piezoelectric bodies formed by joining a plurality of piezoelectric bodies in a laminated structure can produce a displacement volume that is greater in comparison with that of a single-layer piezoelectric body, so it is possible to ensure a higher density of nozzles and to discharge high-viscosity liquid with a configuration in which the laminated piezoelectric bodies are discretely disposed in a corresponding relationship with the pressure chambers. The laminated piezoelectric bodies in the present aspect are discretely and independently arranged for each pressure chamber, and the laminated piezoelectric bodies of neighboring pressure chambers are mutually isolated from each other (independent), so crosstalk during discharge driving is prevented.

Furthermore, in accordance with the present aspect, the degree of freedom to mount laminated piezoelectric bodies during manufacturing is increased because the vibration plate side of the laminated piezoelectric bodies is fixedly joined to the vibration plate and the opposite side is an unrestricted end (free end) that is not bound in any way. Fine tension adjustment or the like is thereby dispensed with, manufacturing is facilitated, and lower costs can be achieved.

The droplet discharge head related to second aspect of the present invention has a plurality of nozzles for discharging droplets, a plurality of pressure chambers provided correspondingly to the plurality of nozzles and filled with liquid to be discharged from the nozzles, a vibration plate constituting one of the wall surfaces of the pressure chambers, and a plurality of laminated piezoelectric bodies fixedly joined at independent positions on the vibration plate that correspond to the plurality of pressure chambers; wherein a weight member is provided to the end portion of the laminated piezoelectric bodies on the side opposite from the joint surface with the vibration plate, for impeding the displacement of the end portion in the direction of pressurization toward the vibration plate, and pressure is applied to the liquid inside the pressure chamber via the vibration plate by expansion and contraction displacement produced by the laminated piezoelectric bodies to discharge droplets from the nozzles.

In accordance with the second aspect of the present invention, the density of the nozzles can be increased, high-viscosity liquid discharged, crosstalk prevented, manufacturing suitability improved, and other advantages obtained in the same manner as the invention according to the first aspect. Furthermore, a load is added by the weight member provided to the end portion of the laminated piezoelectric bodies, a considerable amount of the elongation/contraction displacement of the laminated piezoelectric bodies can be distributed to the joining surface side, and a greater displacement volume can be obtained. The density of the nozzles can thereby be further increased, and high-viscosity liquid can be discharged.

The invention according to the third aspect is related to the droplet discharge head according to first and second aspects wherein, with respect to the planar shape of the pressure chamber viewed from the vibration plate side, the formula 0.45≦aspect ratio≦0.89 is satisfied for the pressure chamber, where the aspect ratio of the pressure chamber is the value of the ratio defined by the minimum value/maximum value of the distance between the walls of the pressure chamber.

When the aspect ratio of the pressure chamber defined as the ratio (minimum value/maximum value) of the minimum and maximum values of the distance (line-of-sight distance) between the walls in the pressure chamber satisfies the condition 0.45≦aspect ratio≦0.89, the shape which allows the vibration plate to easily be displaced is synergistic with the considerable amount of displacement of the laminated piezoelectric bodies, and the displacement amount of the vibration plate with respect to the pressurization force can be made relatively large. In other words, the amount of variation in the volume (displacement volume) of the pressure chamber per unit of occupied surface area can be increased. Therefore, in accordance with the present invention, this allows high-viscosity liquid to be discharged, or allows the size of the head to be reduced in a manner that is not made available in the prior art.

The droplet discharge head related to fourth aspect of the present invention has a plurality of nozzles for discharging droplets, a plurality of pressure chambers provided correspondingly to the plurality of nozzles and filled with liquid to be discharged from the nozzles, a vibration plate constituting one of the wall surfaces of the pressure chambers, and a plurality of laminated piezoelectric bodies fixedly joined at independent positions on the vibration plate that correspond to the plurality of pressure chambers; wherein, with respect to the planar shape of the pressure chamber viewed from the vibration plate side, the formula 0.45≦aspect ratio≦0.89 is satisfied for the aspect ratio of the pressure chamber defined by the minimum/maximum values of the distance between the walls of the pressure chamber, and pressure is applied to the liquid inside the pressure chamber via the vibration plate by expansion and contraction displacement produced by the laminated piezoelectric bodies to discharge droplets from the nozzles.

In accordance with the fourth aspect of the present invention, crosstalk between the nozzles can be prevented by a structure in which the laminated piezoelectric bodies are given an isolated arrangement, and the ability to deform the pressure chambers with the laminated piezoelectric bodies is enhanced, so the density of the nozzles can be increased and high-viscosity liquid can be discharged.

The fifth aspect of the present invention provides an inkjet recording apparatus in which the liquid discharge head of any of the first to fourth aspects is used as an inject recording head, and images are recorded on a recording medium by discharging ink droplets from the nozzles while the recording medium is relatively moved with respect to the inkjet recording head.

In the implementation of the present invention, the shape of the recording head is not particularly limited, and the print head may be a shuttle-type recording head that prints while reciprocating in the direction that is substantially orthogonal to the feed direction of the recording medium, or a full-line recording head having nozzle rows in which a plurality of nozzles for discharging ink are arrayed across a length that corresponds to the entire width of the recording medium in a direction that is substantially orthogonal to the feed direction of the recording medium.

A “full-line recording head (droplet discharge head)” is normally disposed along the direction orthogonal to the relative feed direction of the recording medium, but also possible is an aspect in which the recording head is disposed along the diagonal direction given a predetermined angle with respect to the direction orthogonal to the feed direction. The array form of the nozzles in the recording head is not limited to a single row array in the form of a line, but a matrix array composed of a plurality of rows is also possible. Also possible is an aspect in which a plurality of short-length recording head units having a row of nozzles that do not have lengths that correspond to the entire width of the recording medium are combined and the image-recording element rows are configured so as to correspond to the entire width of the recording medium, with these units acting as a whole.

The “recording medium” is a medium (an object that may be referred to as a print medium, image formation medium, recording medium, image receiving medium, or the like) on which images are recorded by the action of a recording head, and includes continuous paper, cut paper, seal paper, OHP sheets, and other resin sheets, as well as film, cloth, printed boards on which wiring patterns or the like are formed by the inkjet recording apparatus and various other media without regard to materials or shapes. In the present specification, the term “printing” expresses the concept of not only the formation of characters, but also the formation of images with a broad meaning that includes characters.

The term “moving means” (conveyance means) includes an aspect in which the recording medium is moved with respect to a stationary (fixed) recording head, an aspect in which the recording head is moved with respect to a stationary recording medium, or an aspect in which both the recording head and the recording medium are moved.

In accordance with the present invention, a structure is provided such that laminated piezoelectric bodies are discretely and independently disposed on a vibration plate for each pressure chamber in communication with the nozzles, and one of the ends on the side opposite from the joining surface of the vibration plate is an unrestricted end or an end provided with a weight member, so crosstalk between nozzles can be prevented, nozzle density can be increased, high-viscosity liquid can be discharged, and manufacturing can be made simple.

In accordance with another aspect of the present invention, the shape of the pressure chambers in communication with the nozzles is such that the aspect ratio of the planar shape thereof is 0.45 or greater and 0.89 or less, and a discrete laminated piezoelectric body is provided to each pressure chamber, so high-viscosity liquid can be discharged, or the size of the head can be reduced in a manner that is not made available by prior art by a synergistic effect between the considerable drive force of the laminated piezoelectric bodies and the shape that allows the vibration plate to easily be displaced.

### BRIEF DESCRIPTION OF THE DRAWINGS

FIG. 1 is an overall block diagram of an inkjet recording apparatus related to an embodiment of the present invention;

FIG. 2 is a partial plan view of the area around the printing unit of the inkjet recording apparatus shown in FIG. 1;

FIG. 3A is a perspective plan view showing a structural example of the print head;

FIG. 3B is an enlarged view of the principal components in FIG. 3A;

FIG. 3C is a perspective plan view showing another structural example of the print head;

FIG. 4 is a cross-sectional view along line 4-4 in FIG. 3A;

FIG. 5 is an enlarged view showing the nozzle array of the print head shown in FIG. 3A;

FIG. 6 is a schematic diagram showing the ink supply system in the inkjet recording apparatus related to the present embodiment;

FIG. 7 is a partial block view showing the system configuration of the inkjet recording apparatus 10 of the present example;

FIG. 8 is a cross-sectional view showing an example in which a weight member is provided to a side end portion of a laminated piezoelectric body;

FIG. 9 is cross-sectional view showing an example in which a projection is provided to the surface on which piezoelectric bodies are joined with the vibration plate;

FIG. 10 is a cross-sectional view showing an example of the lamination direction of the laminated piezoelectric bodies;

FIGS. 11A and 11B are diagrams used for describing the aspect ratio of a pressure chamber;

FIG. 12 is a table showing the relationship between the shape of a pressure chamber and the displacement amount of the vibration plate;

FIG. 13A is a graph showing the relationship between the shape (vertical dimension a) of the pressure chamber and the displacement amount of the vibration plate;

FIG. 13B is a graph showing the relationship between the shape (horizontal to vertical ratio k) of the pressure chamber and the displacement amount of the vibration plate;

FIG. 13C is a graph showing the relationship between the shape (aspect ratio b/√(a²+b²)) of the pressure chamber and the displacement amount of the vibration plate;

FIG. 14 is a table showing the correspondence relationship between the aspect ratio and the shape of a pressure chamber (horizontal to vertical ratio k).

### DESCRIPTION OF THE PREFERRED EMBODIMENTS

Following is detailed description of the preferred embodiments of the present invention referring to drawings.

General Configuration of an Inkjet Recording Apparatus

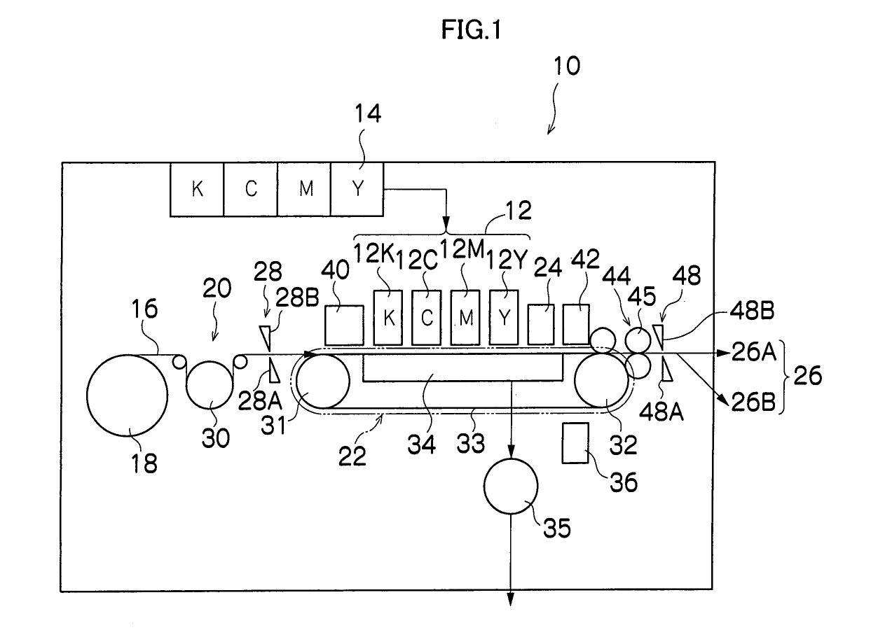

FIG. 1 is a general schematic drawing of an ink-jet recording apparatus according to an embodiment of the present invention. As shown in FIG. 1, the inkjet recording apparatus 10 comprises: a printing unit 12 having a plurality of print heads 12K, 12C, 12M, and 12Y for ink colors of black (K), cyan (C), magenta (M), and yellow (Y), respectively; an ink storing/loading unit 14 for storing inks to be supplied to the print heads 12K, 12C, 12M, and 12Y; a paper supply unit 18 for supplying recording paper 16; a decurling unit 20 for removing curl in the recording paper 16; a suction belt conveyance unit 22 disposed facing the nozzle face (ink-droplet ejection face) of the print unit 12, for conveying the recording paper 16 while keeping the recording paper 16 flat; a print determination unit 24 for reading the printed result produced by the printing unit 12; and a paper output unit 26 for outputting image-printed recording paper (printed matter) to the exterior.

In FIG. 1, a single magazine for rolled paper (continuous paper) is shown as an example of the paper supply unit 18; however, a plurality of magazines with paper differences such as paper width and quality may be jointly provided. Moreover, paper may be supplied with a cassette that contains cut paper loaded in layers and that is used jointly or in lieu of a magazine for rolled paper.

In the case of a configuration in which a plurality of types of recording paper can be used, it is preferable that a information recording medium such as a bar code and a wireless tag containing information about the type of paper is attached to the magazine, and by reading the information contained in the information recording medium with a predetermined reading device, the type of paper to be used is automatically determined, and ink-droplet ejection is controlled so that the ink-droplets are ejected in an appropriate manner in accordance with the type of paper.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is preferably controlled so that the recording paper 16 has a curl in which the surface on which the print is to be made is slightly round outward.

In the case of the configuration in which roll paper is used, a cutter (first cutter) 28 is provided as shown in FIG. 1, and the continuous paper is cut into a desired size by the cutter 28. The cutter 28 has a stationary blade 28A, whose length is equal to or greater than the width of the conveyor pathway of the recording paper 16, and a round blade 28B, which moves along the stationary blade 28A. The stationary blade 28A is disposed on the reverse side of the printed surface of the recording paper 16, and the round blade 28B is disposed on the printed surface side across the conveyor pathway. When cut paper is used, the cutter 28 is not required.

The decurled and cut recording paper 16 is delivered to the suction belt conveyance unit 22. The suction belt conveyance unit 22 has a configuration in which an endless belt 33 is set around rollers 31 and 32 so that the portion of the endless belt 33 facing at least the nozzle face of the printing unit 12 and the sensor face of the print determination unit 24 forms a horizontal plane (flat plane).

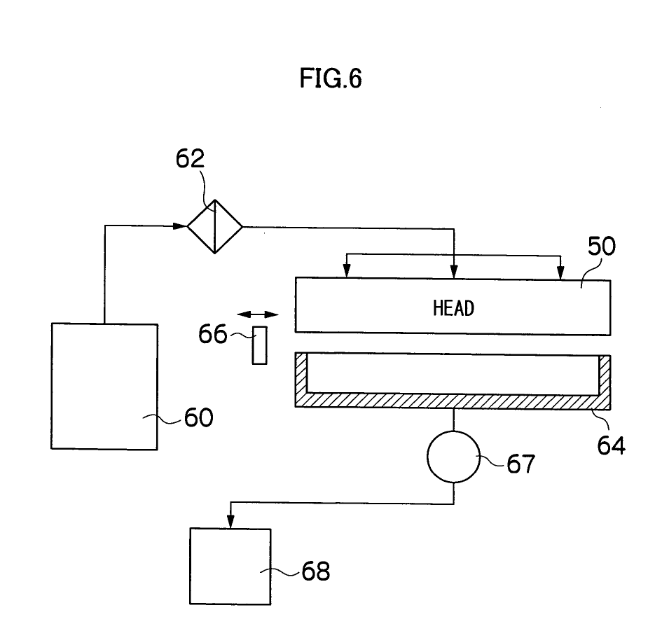

The belt 33 has a width that is greater than the width of the recording paper 16, and a plurality of suction apertures (not shown) are formed on the belt surface. A suction chamber 34 is disposed in a position facing the sensor surface of the print determination unit 24 and the nozzle surface of the printing unit 12 on the interior side of the belt 33, which is set around the rollers 31 and 32, as shown in FIG. 1; and the suction chamber 34 provides suction with a fan 35 to generate a negative pressure, and the recording paper 16 is held on the belt 33 by suction. The belt 33 is driven in the clockwise direction in FIG. 1 by the motive force of a motor (not shown in FIG. 1, but shown as a motor 88 in FIG. 7) being transmitted to at least one of the rollers 31 and 32, which the belt 33 is set around, and the recording paper 16 held on the belt 33 is conveyed from left to right in FIG. 1.

Since ink adheres to the belt 33 when a marginless print job or the like is performed, a belt-cleaning unit 36 is disposed in a predetermined position (a suitable position outside the printing area) on the exterior side of the belt 33. Although the details of the configuration of the belt-cleaning unit 36 are not depicted, examples thereof include a configuration in which the belt 33 is nipped with a cleaning roller such as a brush roller and a water absorbent roller, an air blow configuration in which clean air is blown onto the belt 33, or a combination of these. In the case of the configuration in which the belt 33 is nipped with the cleaning roller, it is preferable to make the line velocity of the cleaning roller different than that of the belt 33 to improve the cleaning effect.

The inkjet recording apparatus 10 can comprise a roller nip conveyance mechanism, in which the recording paper 16 is pinched and conveyed with nip rollers, instead of the suction belt conveyance unit 22. However, there is a drawback in the roller nip conveyance mechanism that the print tends to be smeared when the printing area is conveyed by the roller nip action because the nip roller makes contact with the printed surface of the paper immediately after printing. Therefore, the suction belt conveyance in which nothing comes into contact with the image surface in the printing area is preferable.

A heating fan 40 is disposed on the upstream side of the printing unit 12 in the conveyance pathway formed by the suction belt conveyance unit 22. The heating fan 40 blows heated air onto the recording paper 16 to heat the recording paper 16 immediately before printing so that the ink deposited on the recording paper 16 dries more easily.

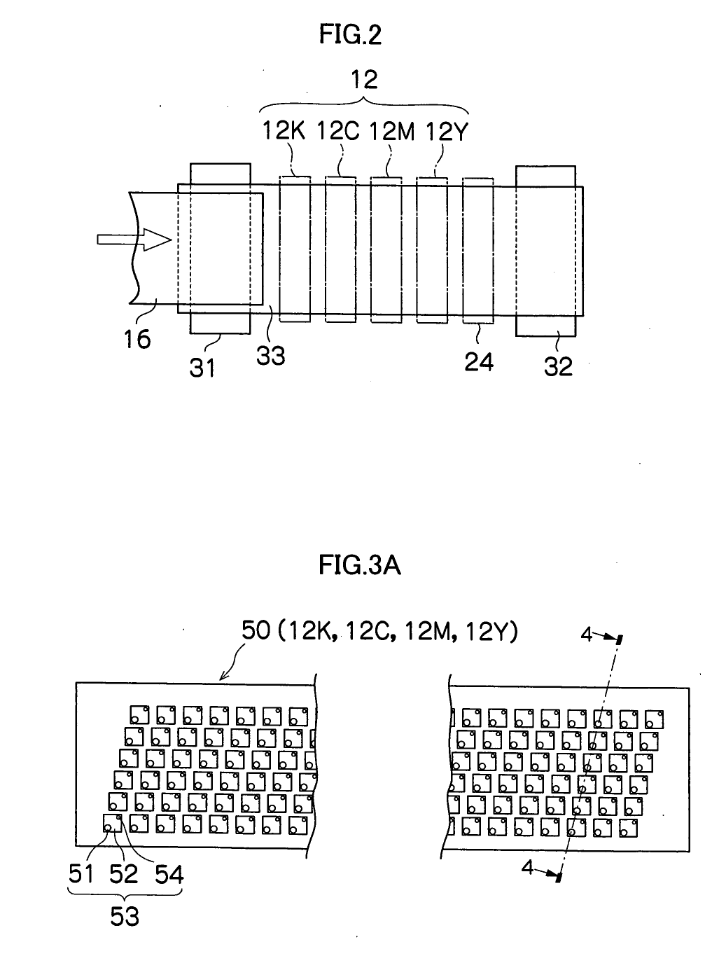

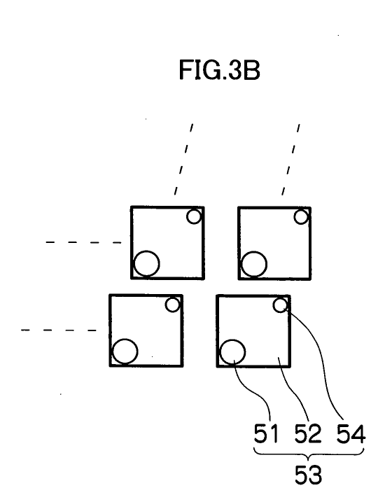

As shown in FIG. 2, the printing unit 12 forms a so-called full-line head in which a line head having a length that corresponds to the maximum paper width is disposed in the direction perpendicular to the delivering direction of the recording paper 16 (hereinafter referred to as the paper conveyance direction) represented by the arrow in FIG. 2, which is substantially perpendicular to a width direction of the recording paper 16. A specific structural example is described later with reference to FIGS. 3A to 5. Each of the print heads 12K, 12C, 12M, and 12Y is composed of a line head, in which a plurality of ink-droplet ejection apertures (nozzles) are arranged along a length that exceeds at least one side of the maximum-size recording paper 16 intended for use in the inkjet recording apparatus 10, as shown in FIG. 2.

The print heads 12K, 12C, 12M, and 12Y are arranged in this order from the upstream side along the paper conveyance direction. A color print can be formed on the recording paper 16 by ejecting the inks from the print heads 12K, 12C, 12M, and 12Y, respectively, onto the recording paper 16 while conveying the recording paper 16.

Although the configuration with the KCMY four standard colors is described in the present embodiment, combinations of the ink colors and the number of colors are not limited to those, and light and/or dark inks can be added as required. For example, a configuration is possible in which print heads for ejecting light-colored inks such as light cyan and light magenta are added. Moreover, a configuration is possible in which a single print head adapted to record an image in the colors of CMY or KCMY is used instead of the plurality of print heads for the respective colors.

The print unit 12, in which the full-line heads covering the entire width of the paper are thus provided for the respective ink colors, can record an image over the entire surface of the recording paper 16 by performing the action of moving the recording paper 16 and the print unit 12 relatively to each other in the sub-scanning direction just once (i.e., with a single sub-scan). Higher-speed printing is thereby made possible and productivity can be improved in comparison with a shuttle type head configuration in which a print head reciprocates in the main scanning direction.

As shown in FIG. 1, the ink storing/loading unit 14 has tanks (ink tanks) for storing the inks to be supplied to the print heads 12K, 12C, 12M, and 12Y, and the tanks are connected to the print heads 12K, 12C, 12M, and 12Y through channels (not shown), respectively. The ink storing/loading unit 14 has a warning device (e.g., a display device, an alarm sound generator) for warning when the remaining amount of any ink is low, and has a mechanism for preventing loading errors among the colors.

The print determination unit 24 has an image sensor for capturing an image of the ink-droplet deposition result of the print unit 12, and functions as a device to check for ejection defects such as clogs of the nozzles in the print unit 12 from the ink-droplet deposition results evaluated by the image sensor. The print determination unit 24 of the present embodiment is configured with at least a line sensor or an area sensor having rows of photoelectric transducing elements with a width that is greater than the ink-droplet ejection width (image recording width) of the print heads 12K, 12C, 12M, and 12Y.

A post-drying unit 42 is disposed following the print determination unit 24. The post-drying unit 42 is a device to dry the printed image surface, and includes a heating fan, for example. It is preferable to avoid contact with the printed surface until the printed ink dries, and a device that blows heated air onto the printed surface is preferable.

In cases in which printing is performed with dye-based ink on porous paper, blocking the pores of the paper by the application of pressure prevents the ink from coming contact with ozone and other substance that cause dye molecules to break down, and has the effect of increasing the durability of the print.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are preferably outputted separately. In the inkjet recording apparatus 10, a sorting device (not shown) is provided for switching the outputting pathway in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48. The cutter 48 is disposed directly in front of the paper output unit 26, and is used for cutting the test print portion from the target print portion when a test print has been performed in the blank portion of the target print. The structure of the cutter 48 is the same as the first cutter 28 described above, and has a stationary blade 48A and a round blade 48B.

Although not shown in FIG. 1, a sorter for collecting prints according to print orders is provided to the paper output unit 26A for the target prints.

Next, the structure of the print heads is described. The print heads 12K, 12C, 12M, and 12Y provided for the ink colors have the same structure, and a reference numeral 50 is hereinafter designated to any of the print heads 12K, 12C, 12M, and 12Y.

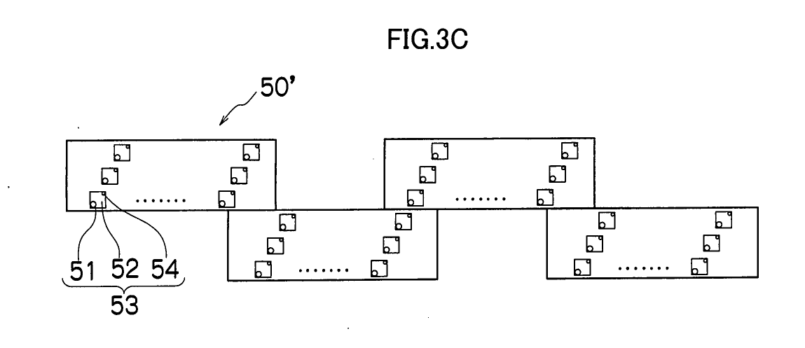

FIG. 3A is a perspective plan view showing an example of the configuration of the print head 50, FIG. 3B is an enlarged view of a portion thereof, FIG. 3C is a perspective plan view showing another example of the configuration of the print head 50, and FIG. 4 is a cross-sectional view taken along the line 4-4 in FIG. 3A, showing the inner structure of an ink chamber unit.

The nozzle pitch in the print head 50 should be minimized in order to maximize the density of the dots printed on the surface of the recording paper. As shown in FIGS. 3A, 3B, 3C and 4, the print head 50 in the present embodiment has a structure in which a plurality of ink chamber units 53 including nozzles 51 for ejecting ink-droplets and pressure chambers 52 connecting to the nozzles 51 are disposed in the form of a staggered matrix in two dimensions, and the effective nozzle pitch is thereby made small.

As shown in FIGS. 3A, 3B and 3C, the print head 50 of the present embodiment is a full-line head having at least one row of nozzles 51 ejecting the inks, the nozzles being disposed in the direction perpendicular to the delivering direction of the recording medium and in a length that corresponds to the maximum width of the recording medium.

In execution of the present invention, the structure of disposing of the nozzle is not limited to the example shown in the attached drawings. As shown in FIG. 3C, short length head unit 50′ disposed in a staggered arrangement may be used in which the nozzles 51 are disposed in two dimension, so that a full-line head having a row of nozzles with length corresponding to entire length of the recording paper is formed.

As shown in FIGS. 3A to 3C, the pressure chamber 52 disposed corresponding to each nozzle 51 is substantially rectangular in plan view and has the nozzle 51 and the supply port 54 at both corners on a diagonal line.

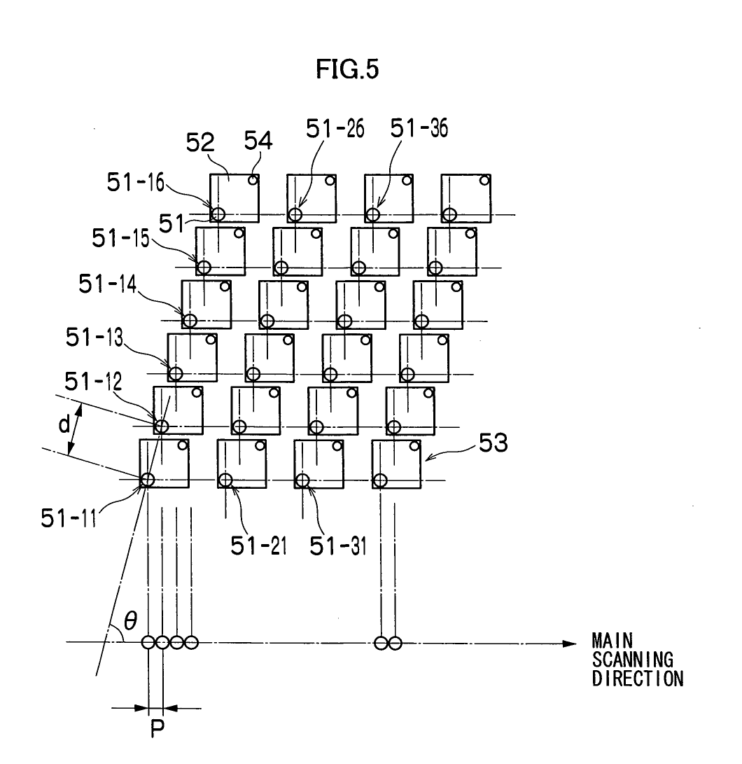

As shown in FIG. 4, each pressure chamber 52 is connected to a common flow channel 55 through the supply port 54. The common flow channel 55 is connected to an ink tank (not shown in FIG. 4, but shown as 60 in FIG. 6) which supplies the ink. The ink supplied from the ink tank is supplied to each pressure chamber 52 through the common flow channel 55. A sub tank (not shown) other than the ink tank 60 may be disposed near the print head 50 or in the print head 50. The sub tank has damper effect for preventing inner pressure fluctuation of the print head and useful in improving of refill function.

The nozzles 51 are in communication with the pressure chambers 52 by way of the nozzle flow channels 56, as shown in FIG. 4. Laminated piezoelectric bodies 58 are joined as individually separated independent structures in positions corresponding to the pressure chambers 52 on the vibration plate 57 constituting the top surface of the pressure chambers 52. The laminated piezoelectric bodies 58 have a structure in which thin plates of piezoelectric bodies and internal electrodes are alternately overlaid. The vibration plate 57 in the present example also serves as the common electrode for the laminated piezoelectric bodies 58.

A flexible substrate 59 is connected to the end portions (the upper end in FIG. 4) on the free end side of the laminated piezoelectric bodies 58. Wiring patterns corresponding to the separate electrodes of the laminated piezoelectric bodies 58 are formed on the flexible substrate 59, and drive voltage is applied to the individual laminated piezoelectric bodies 58 by way of the flexible substrate 59. When drive voltage is applied to the laminated piezoelectric bodies 58, the laminated piezoelectric bodies 58 deform by expanding and contracting in the lamination direction, ink inside the pressure chamber 52 is pressurized in conjunction with the displacement thereof, and the ink is discharged from the nozzle 51. When the ink is discharged, new ink is fed from the common flow channel 55 through the supply port 54 to the pressure chamber 52.

The flexible substrate 59, which is composed of a flexible resin material, bridges and connects a plurality of laminated piezoelectric bodies 58, but it is not restricted on the upper end portion of the individual laminated piezoelectric bodies 58. Therefore, the upper end portion (the end portion on the side opposite from the joining surface of the vibration plate 57) of each of the laminated piezoelectric bodies 58 is in a free-end state that allows displacement in the pressurizing direction of the vibration plate 57.

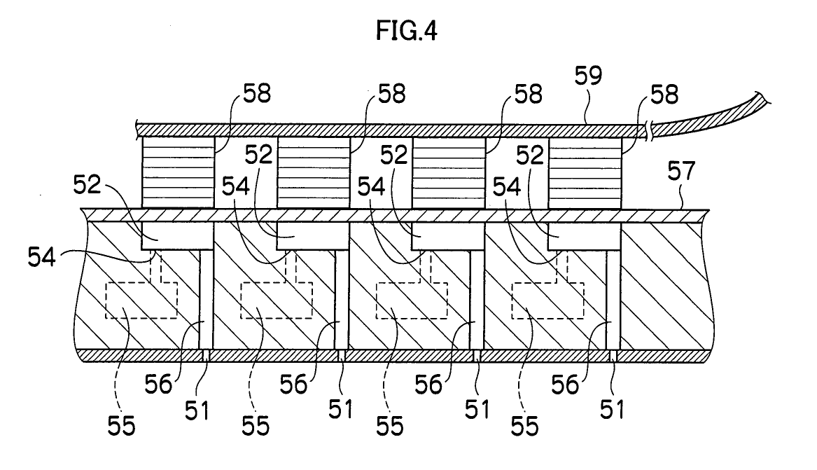

In the print head 50 of the present embodiment, the plurality of ink chamber units 53 having such a structure are arranged in a grid with a fixed pattern in the line-printing direction along the main scanning direction and in the diagonal-row direction forming a fixed angle θ that is not a right angle with the main scanning direction, as shown in FIG. 5.

As shown in FIG. 5, with the structure in which the plurality of rows of ink chamber units 53 are arranged at a fixed pitch d in the direction at the angle θ with respect to the main scanning direction, the nozzle pitch P as projected in the main scanning direction is d×cos θ.

Hence, the nozzles 51 can be regarded to be equivalent to those arranged at a fixed pitch P on a straight line along the main scanning direction. Such configuration results in a nozzle structure in which the nozzle row projected in the main scanning direction has a high nozzle density of up to 2,400 nozzles per inch.

In a full-line head comprising rows of nozzles that have a length corresponding to the entire width of the paper (the recording paper 16), the “main scanning” is defined as to print one line (a line formed of a row of dots, or a line formed of a plurality of rows of dots) in the width direction of the recording paper (the direction perpendicular to the delivering direction of the recording paper) by driving the nozzles in one of the following ways: (1) simultaneously driving all the nozzles; (2) sequentially driving the nozzles from one side toward the other; and (3) dividing the nozzles into blocks and sequentially driving the blocks of the nozzles from one side toward the other.

In particular, when the nozzles 51 arranged in a matrix such as that shown in FIG. 5 are driven, the main scanning according to the above-described (3) is preferred. More specifically, the nozzles 51-11, 51-12, 51-13, 51-14, 51-15 and 51-16 are treated as a block (additionally; the nozzles 51-21, 51-22, . . . , 51-26 are treated as another block; the nozzles 51-31, 51-32, . . . , 51-36 are treated as another block, . . . ); and one line is printed in the width direction of the recording paper 16 by sequentially driving the nozzles 51-11, 51-12, . . . , 51-16 in accordance with the conveyance velocity of the recording paper 16.

On the other hand, the “sub-scanning” is defined as to repeatedly perform printing of one line (a line formed of a row of dots, or a line formed of a plurality of rows of dots) formed by the main scanning, while moving the full-line head and the recording paper relatively to each other.

Composition of Ink Supply System

FIG. 6 is a schematic drawing showing the configuration of the ink supply system in the inkjet recording apparatus 10. An ink supply tank 60 is a base tank that supplies ink and is set in the ink storing and loading unit 14 described with reference to FIG. 1. The aspects of the ink supply tank 60 include a refillable type and a cartridge type: when the remaining amount of ink is low, the ink supply tank 60 of the refillable type is filled with ink through a filling port (not shown) and the ink supply tank 60 of the cartridge type is replaced with a new one. In order to change the ink type in accordance with the intended application, the cartridge type is suitable, and it is preferable to represent the ink type information with a bar code or the like on the cartridge, and to perform ejection control in accordance with the ink type. The ink supply tank 60 in FIG. 6 is equivalent to the ink storing and loading unit 14 in FIG. 1 described above.

A filter 62 for removing foreign matters and bubbles is disposed between the ink supply tank 60 and the print head 50 as shown in FIG. 6. The filter mesh size in the filter 62 is preferably equivalent to or less than the diameter of the nozzle and commonly about 20 μm.

Although not shown in FIG. 6, it is preferable to provide a sub-tank integrally to the print head 50 or nearby the print head 50. The sub-tank has a damper function for preventing variation in the internal pressure of the head and a function for improving refilling of the print head.

The inkjet recording apparatus 10 is also provided with a cap 64 as a device to prevent the nozzles 51 from drying out or to prevent an increase in the ink viscosity in the vicinity of the nozzles 51, and a cleaning blade 66 as a device to clean the nozzle face.

A maintenance unit including the cap 64 and the cleaning blade 66 can be moved in a relative fashion with respect to the print head 50 by a movement mechanism (not shown), and is moved from a predetermined holding position to a maintenance position below the print head 50 as required.

The cap 64 is displaced up and down in a relative fashion with respect to the print head 50 by an elevator mechanism (not shown). When the power of the inkjet recording apparatus 10 is switched OFF or when in a print standby state, the cap 64 is raised to a predetermined elevated position so as to come into close contact with the print head 50, and the nozzle face is thereby covered with the cap 64.

The cleaning blade 66 is composed of rubber or another elastic member, and can slide on the ink discharge surface (surface of the nozzle plate) of the print head 50 by means of a blade movement mechanism (not shown). When ink droplets or foreign matter has adhered to the nozzle plate, the surface of the nozzle plate is wiped, and the surface of the nozzle plate is cleaned by sliding the cleaning blade 66 on the nozzle plate.

During printing or standby, when the frequency of use of specific nozzles is reduced and ink viscosity increases in the vicinity of the nozzles, a preliminary discharge is made toward the cap 64 to discharge the degraded ink.

Also, when bubbles have become intermixed in the ink inside the print head 50 (inside the pressure chamber), the cap 64 is placed on the print head 50, ink (ink in which bubbles have become intermixed) inside the pressure chamber 52 is removed by suction with a suction pump 67, and the suction-removed ink is sent to a collection tank 68. This suction action entails the suctioning of degraded ink whose viscosity has increased (hardened) when initially loaded into the head, or when service has started after a long period of being stopped.

When a state in which ink is not discharged from the print head 50 continues for a certain amount of time or longer, the ink solvent in the vicinity of the nozzles 51 evaporates and ink viscosity increases. In such a state, ink can no longer be discharged from the nozzle 51 even if the actuator (the laminated piezoelectric bodies 58) is operated. Before reaching such a state the actuator 58 is operated (in a viscosity range that allows discharge by the operation of the actuator), and the preliminary discharge is made toward the ink receptor to which the ink whose viscosity has increased in the vicinity of the nozzle is to be discharged. After the nozzle surface is cleaned by a wiper such as the cleaning blade 66 provided as the cleaning device for the nozzle face, a preliminary discharge is also carried out in order to prevent the foreign matter from becoming mixed inside the nozzles 51 by the wiper sliding operation. The preliminary discharge is also referred to as “dummy discharge”, “purge”, “liquid discharge”, and so on.

When bubbles have become intermixed in the nozzle 51 or the pressure chamber 52, or when the ink viscosity inside the nozzle 51 has increased over a certain level, ink can no longer be discharged by the preliminary discharge, and a suctioning action is carried out as follows.

More specifically, when bubbles have become intermixed in the ink inside the nozzle 51 and the pressure chamber 52, ink can no longer be discharged from the nozzles even if the actuator 58 is operated. Also, when the ink viscosity inside the nozzle 51 has increased over a certain level, ink can no longer be discharged from the nozzle 51 even if the actuator 58 is operated. In these cases, a suctioning device to remove the ink inside the pressure chamber 52 by suction with a suction pump, or the like, is placed on the nozzle face of the print head 50, and the ink in which bubbles have become intermixed or the ink whose viscosity has increased is removed by suction.

However, this suction action is performed with respect to all the ink in the pressure chamber 52, so that the amount of ink consumption is considerable. Therefore, a preferred aspect is one in which a preliminary discharge is performed when the increase in the viscosity of the ink is small.

The cap 64 described with reference to FIG. 6 serves as the suctioning device and also as the ink receptacle for the preliminary discharge.

Description of Control System

Control system of the inkjet apparatus 10 is explained as follows.

FIG. 7 is a block diagram of the principal components showing the system configuration of the inkjet recording apparatus 10. The inkjet recording apparatus 10 has a communication interface 70, a system controller 72, an image memory 74, a motor driver 76, a heater driver 78, a print controller 80, an image buffer memory 82, a head driver 84, and other components.

The communication interface 70 is an interface unit for receiving image data sent from a host computer 86. A serial interface such as USB, IEEE1394, Ethernet, wireless network, or a parallel interface such as a Centronics interface may be used as the communication interface 70. A buffer memory (not shown) may be mounted in this portion in order to increase the communication speed. The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to memory composed of a semiconductor element, and a hard disk drive or another magnetic medium may be used.

The system controller 72 controls the communication interface 70, image memory 74, motor driver 76, heater driver 78, and other components. The system controller 72 has a central processing unit (CPU), peripheral circuits therefor, and the like. The system controller 72 controls communication between itself and the host computer 86, controls reading and writing from and to the image memory 74, and performs other functions, and also generates control signals for controlling a heater 89 and the motor 88 in the conveyance system.

The motor driver (drive circuit) 76 drives the motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data stored in the image memory 74 in accordance with commands from the system controller 72 so as to apply the generated print control signals (image formation data) to the head driver 84. Prescribed signal processing is carried out in the print control unit 80, and the discharge amount and the discharge timing of the ink droplets from the respective print heads 50 are controlled via the head drier 84, on the basis of the image data. By this means, prescribed dot size or dot positions can be achieved.

The print control unit 80 is connected with an image buffer memory 82, image data or various data such as parameter is temporally stored in the image buffer memory 82 when processing image data in the print control unit 80. In FIG. 7, the image buffer memory 82 is indicated as associated with the print control unit 80, the image buffer memory 82 may be shared with the image memory 74. One processor including the print control unit 80 and the system controller 72 can be used.

The head driver 84 drives laminated piezoelectric elements 58 of the print heads 12K, 12C, 12M, and 12Y on the basis of the image formation data supplied from the print control unit 80. The head driver 84 can include feedback control system to keep driving condition of the heads constant.

The print determination unit 24 comprises the line sensor, as described referring to FIG. 1. The print determination unit 24 reads the image printed on the recording paper 16, performs predetermined signal processing to detect printed result (discharged or not, variations of discharged dots) produced by the printing unit 12, and supplies the detected result to the print control unit 80.

The print control unit 80 performs various compensation in controlling the printing heads 50 on the basis of data supplied from the print determination unit 24, if necessary.

Head Manufacturing Method

Here, the manufacturing method for the print head 50 is described.

Recent surface mounting technology provides techniques for arranging and attaching submillimeter size elements on a circuit substrate with a high precision of about 10 μm. It is sufficiently possible to arrange with high precision laminated piezoelectric elements with submillimeter angles in individual pressure chamber positions of the inkjet head.

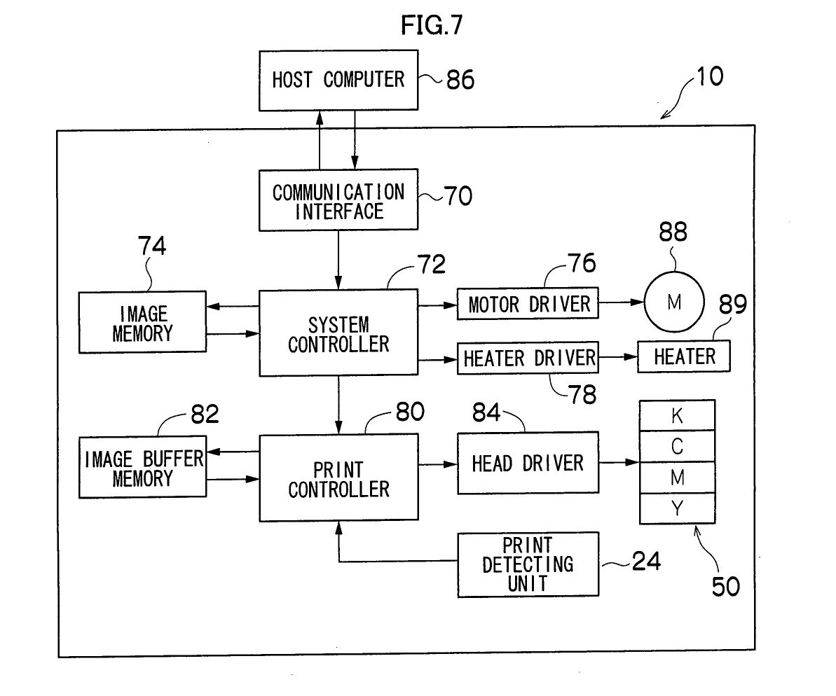

In the fabrication of the print head 50 of the present example, a component obtained by mounting a weight member (designated by key symbol 92 in FIG. 8) on a laminated piezoelectric body 58 or on one end thereof (the end on the opposite side of the vibration plate joining surface) is positioned using the above mounting apparatus in the portion to which pressure is applied to the vibration plate 57, the components are tacked together, and these are thereafter bonded together by UV bonding or thermal bonding.

The elongation/contraction displacement of the laminated piezoelectric body 58 is efficiently transmitted to the pressure chamber 52 (lower portion in FIG. 8) by providing a weight member 92 to the unrestricted end side, which is the opposite side from the surface on which the laminated piezoelectric body 58 is joined with the vibration plate 57, as shown in FIG. 8. The key symbol 94 in FIG. 8 designates a pressure chamber plate constituting the sidewall surface of the pressure chamber 52, and key symbol 95 designates a flow channel plate that constitutes the lower surface of the pressure chamber 52 and also forms the nozzle flow channel 56.

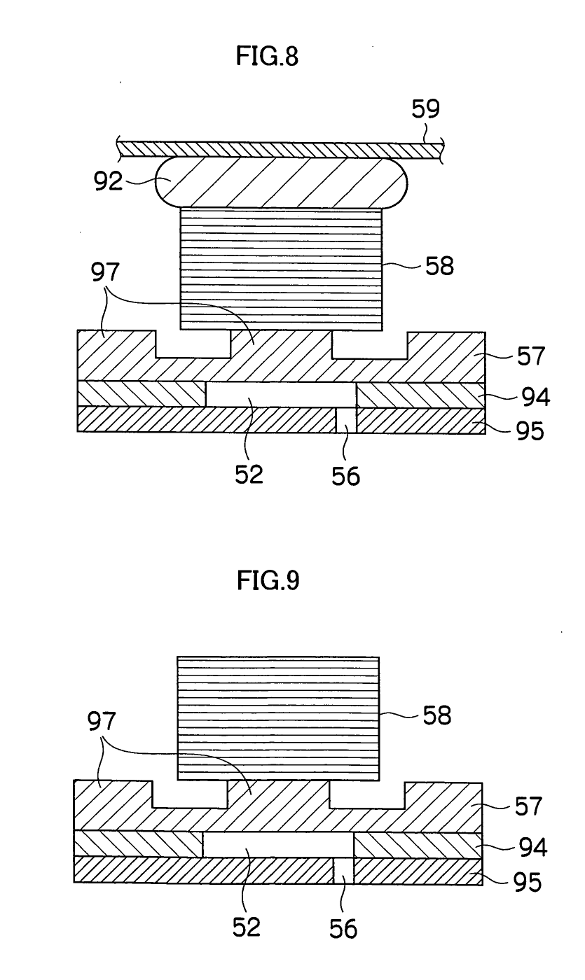

A preferable aspect is one in which projections 97 are provided to the side of the vibration plate 57 on which the piezoelectric body is joined, as shown in FIGS. 8 and 9, and even if the laminated piezoelectric body 58 is positioned only approximately using the concavo-convex structure of the vibration plate 57 created by the projections 97, the pressurization condition of the pressure chamber 52 is substantially evenly aligned, without any dependence on the position of the piezoelectric body.

The method of bringing out electrodes from piezoelectric bodies 58 entails drawing out separate electrodes to the free end side of the piezoelectric bodies 58, and wiring these all at once by way of a flexible substrate 59 or the like to the exterior, as additionally described in FIG. 4.

A shared electrode (common electrode) is electrically connected to the metallic vibration plate 57 by way of an adhesive. Conductivity through the adhesive may be achieved with a roughened surface, or an electrically conductive adhesive may be used.

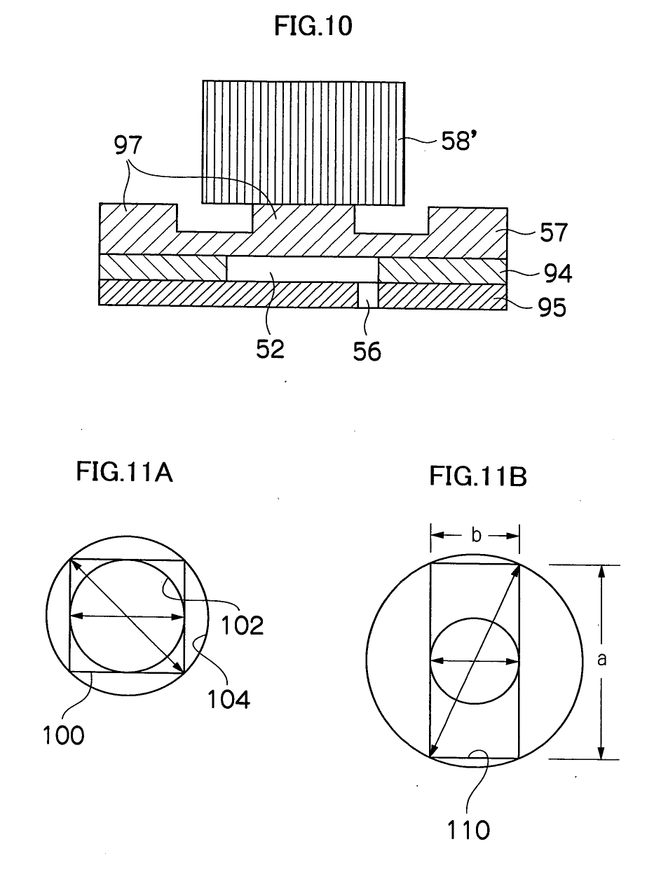

In the print head 50 of the present invention, the laminated piezoelectric bodies 58 are composed of about 10 layers of lamination, so the piezoelectric bodies can operate in an elongation/contraction mode (a mode in which deformation in the d33 direction is utilized). The piezoelectric bodies are laminated by being overlaid in the lengthwise direction (normal direction) with respect to the joining surface of the vibration plate 57, as shown in FIG. 9, or in the transverse direction (direction orthogonal to the normal line) with respect to the joining surface of the vibration plate 57, as in the laminated piezoelectric body 58′ shown in FIG. 10. In this case, the piezoelectric bodies are used in the mode in which displacement in the d31 direction is utilized.

Synergistic Effect Between the Shape of the Pressure Chambers and the Laminated Piezoelectric Bodies

The pressure chambers 52 of the print head 50 related to the present embodiment have a substantially square shape when viewed (in perspective) from the actuator side, as described in FIGS. 3A to 3C.

The operation of the pressure chambers 52 whose shape has a horizontal to vertical ratio of about 1, as is representative of a square shape, is enhanced by the ease with which the vibration plate 57 is displaced by the considerable driving force of the laminated piezoelectric bodies 58, and the generated pressure is even more greatly improved. High-viscosity liquid can thereby be discharged, or the size of the head can be reduced in a manner that is not made available by prior art.

Here, the relationship between the ease with which the vibration plate 57 is displaced and the shape of the pressure chambers 52 is described.

The aspect ratio is defined as follows for the planar shape of the pressure chambers in order to expand this concept beyond the square shape and to make the concept applicable to pressure chambers of various shapes in the same manner.

In other words, the aspect ratio of a pressure chamber is defined by the ratio of the minimum/maximum values of distanced between the walls of the pressure chamber within a plane (perspective distance).

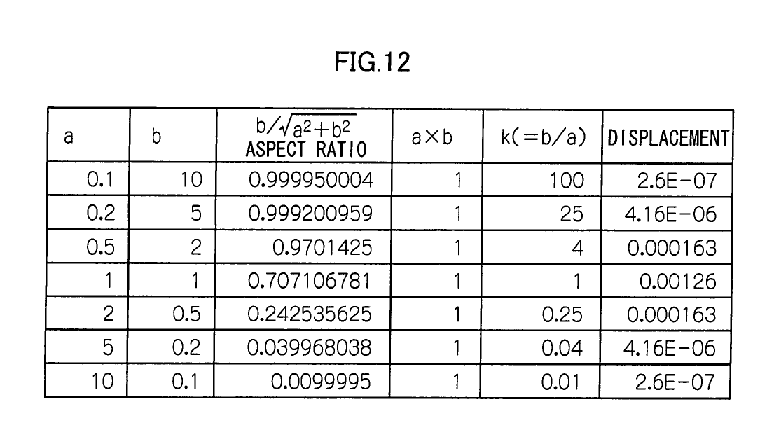

When a pressure chamber 100 has a square shape, the minimum value of the distance between the walls of the pressure chamber is equal to the diameter of the inscribed circle 102, and the maximum value of the distance between the walls is equal to the diameter of the circumscribed circle 104, as shown in FIG. 11A. Therefore, the aspect ratio of the pressure chamber 100 is 1/√2≈0.707.

The planar shape of the pressure chamber 110 is rectangular, and when the length and width sides have a ratio of a:b (a≦b), the aspect ration thereof is b/√(a²+b²), as shown in FIG. 11B.

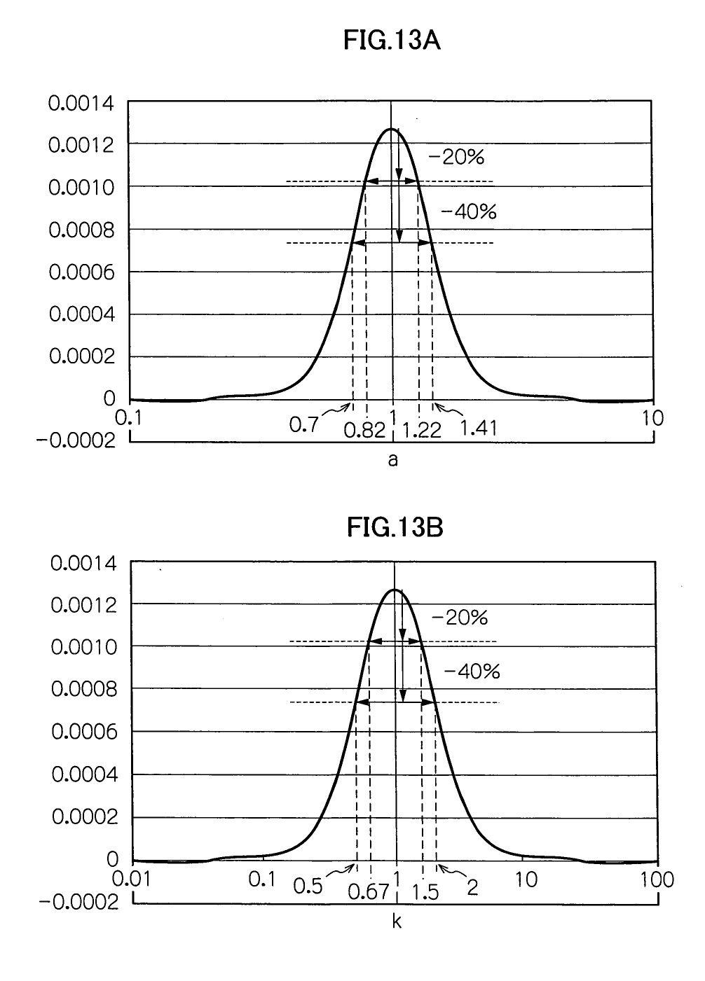

If the ratio is set to a:b=1:k in a pressure chamber (a×b is fixed) with an equal surface area that is restricted on four sides, and the isobaric weighting on the vibration plate of the pressure chamber is assumed, the maximum amount of displacement (relative values) of the vibration plate will be as shown in the table in FIG. 12. In cases in which vibration is generated using the piezoelectric body, it is possible to consider that characteristics will be substantially the same as those in FIG. 12.

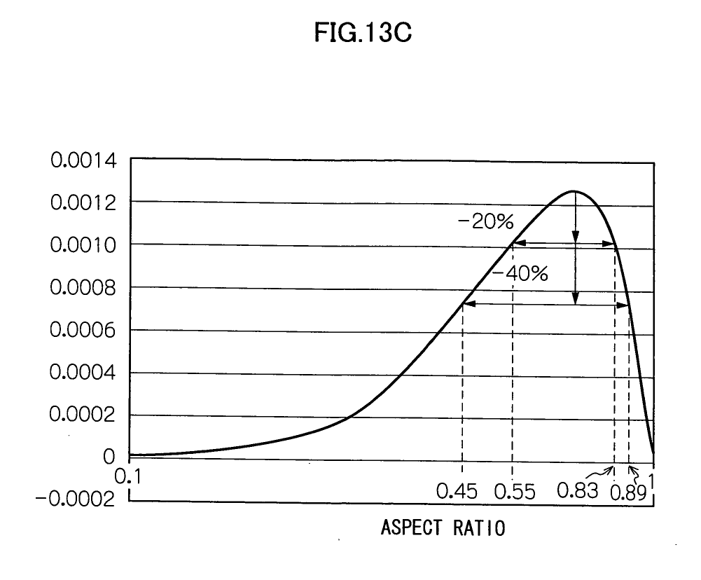

FIGS. 13A to 13C are graphs showing the displacement characteristics of the vibration plate when pressure is applied uniformly to the vibration plate with an equal surface area. FIG. 13A shows the relationship between vertical dimension a of the pressure chamber and displacement, in which the horizontal axis is the vertical dimension a, vertical axis is the normalized amount of the displacement. FIG. 13B shows the relationship between the ratio k and the displacement in which the horizontal axis in the diagram is the ratio k(=b/a). FIG. 13C shows the relationship between the aspect ratio and the displacement in which the horizontal axis in the diagram is the aspect ratio b/√(a²+b²).

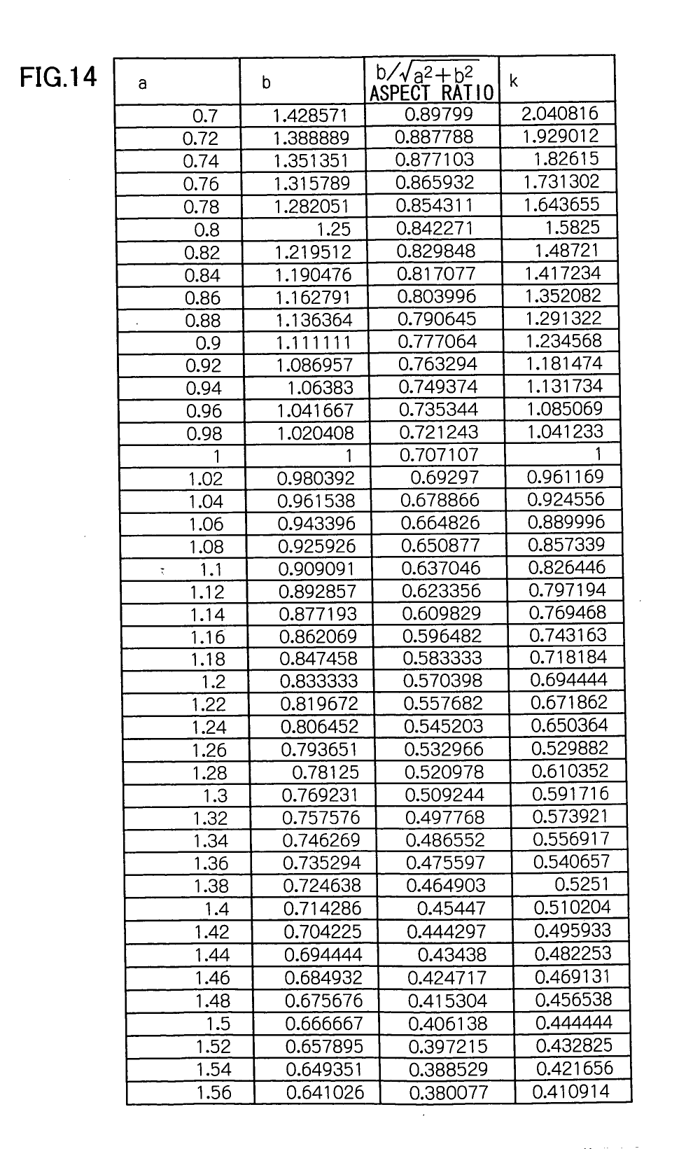

FIG. 14 is a data chart showing the correspondence relationship between the ratio k and the aspect ratio.

As shown in FIG. 13B, the displacement is maximum when k=1. For this maximum displacement, an efficient pressure chamber shape is 0.5≦k≦2, which is the range in which the amplitude in the graph in FIG. 13B is reduced by 40%(that is the range of −40% or less to maximum value), and is more preferably ⅔≦k≦1.5, which is the range in which the amplitude is reduced by 20%(that is the range of −20% or less to maximum value).

The shape of the pressure chamber is not limited to a rectangular shape, so specifying the above aspect ratio so as to enable application to any shape, including a rhomboid, hexagon, or another polygon, yields the expression “0.45≦aspect ratio≦0.89,” and more preferably “0.55≦aspect ratio≦0.83” (refer to FIGS. 13C and 14).

Described in the above embodiments is an inkjet recording apparatus that uses a page-wide full-line head having a row of nozzles with a length corresponding to the entire width of the recording medium, but the applicable scope of the present invention is not limited to this option alone, and the present invention may also be applied to an inkjet recording apparatus that uses a shuttle head for recording images as the short recording head moves in a reciprocating fashion.

An inkjet recording apparatus was described as an example of an image formation apparatus, but the range of applicability of the present invention is not limited thereby. For example, the present invention may also be applied to photographic image formation apparatuses for applying developing solution in a non-contact manner to photographic paper. In other words, the present invention can be widely adapted to other image formation apparatuses with a droplet discharge step that is not limited to the application of ink but can also be used to apply a treatment solution, functional solution, or other solution to a medium. Other than inkjet methods, the present invention may also be applied to optical photographic print production apparatuses, thermal transfer recording apparatuses with a line head, LED electrophotographic printers, silver halide photographic printers with an LED line exposure head, and other types of image formation apparatuses.

The applicable scope of the present invention is not limited to image formation apparatuses and extends to application apparatuses and various other liquid discharge apparatuses in which a treatment solution or other solution is applied to a medium using a droplet discharge head.

1. A droplet discharge head comprising:
a plurality of nozzles for discharging droplets,
a plurality of pressure chambers provided correspondingly to the plurality of nozzles and filled with liquid to be discharged from the nozzles,
a vibration plate constituting one of the wall surfaces of the pressure chambers, and
a plurality of laminated piezoelectric bodies fixedly joined at independent positions on the vibration plate that correspond to the plurality of pressure chambers;
wherein the end portion of the laminated piezoelectric bodies on the side opposite from the joint surface with the vibration plate is formed into an unrestricted end that is displaceable in the direction of pressure applied to the vibration plate by the laminated piezoelectric bodies, and pressure is applied to the liquid inside the pressure chamber via the vibration plate by expansion and contraction displacement produced by the laminated piezoelectric bodies to discharge droplets from the nozzles.

2. A droplet discharge head comprising:
a plurality of nozzles for discharging droplets,
a plurality of pressure chambers provided correspondingly to the plurality of nozzles and filled with liquid to be discharged from the nozzles,
a vibration plate constituting one of the wall surfaces of the pressure chambers, and
a plurality of laminated piezoelectric bodies fixedly joined at independent positions on the vibration plate that correspond to the plurality of pressure chambers;
wherein a weight member is provided to the end portion of the laminated piezoelectric bodies on the side opposite from the joint surface with the vibration plate, for impeding the displacement of the end portion in the direction of pressurization toward the vibration plate, and pressure is applied to the liquid inside the pressure chamber via the vibration plate by expansion and contraction displacement produced by the laminated piezoelectric bodies to discharge droplets from the nozzles.

3. The droplet discharge head according to claim 1, wherein, with respect to the planar shape of the pressure chamber viewed from the vibration plate side, the formula
0.45≦aspect ratio≦0.89
is satisfied for the pressure chamber, where the aspect ratio of the pressure chamber is the value of the ratio defined by the minimum/maximum values of the distance between the walls of the pressure chamber.

4. The droplet discharge head according to claim 2, wherein, with respect to the planar shape of the pressure chamber viewed from the vibration plate side, the formula
0.45≦aspect ratio≦0.89
is satisfied for the pressure chamber, where the aspect ratio of the pressure chamber is the value of the ratio defined by the minimum/maximum values of the distance between the walls of the pressure chamber.

5. A droplet discharge head comprising:
a plurality of nozzles for discharging droplets,
a plurality of pressure chambers provided correspondingly to the plurality of nozzles and filled with liquid to be discharged from the nozzles,
a vibration plate constituting one of the wall surfaces of the pressure chambers, and
a plurality of laminated piezoelectric bodies fixedly joined at independent positions on the vibration plate that correspond to the plurality of pressure chambers;
wherein, with respect to the planar shape of the pressure chamber viewed from the vibration plate side, the formula
0.45≦aspect ratio≦0.89 is satisfied for the aspect ratio of the pressure chamber defined by the minimum/maximum values of the distance between the walls of the pressure chamber, and
pressure is applied to the liquid inside the pressure chamber via the vibration plate by expansion and contraction displacement produced by the laminated piezoelectric bodies to discharge droplets from the nozzles.

6. An inkjet recording apparatus wherein the liquid discharge head of claim 1 is used as an inkjet recording head, and images are recorded on a recording medium by discharging ink droplets from the nozzles while the recording medium is relatively moved with respect to the inkjet recording head.

7. An inkjet recording apparatus wherein the liquid discharge head of claim 2 is used as an inkjet recording head, and images are recorded on a recording medium by discharging ink droplets from the nozzles while the recording medium is relatively moved with respect to the inkjet recording head.

8. An inkjet recording apparatus wherein the liquid discharge head of claim 3 is used as an inkjet recording head, and images are recorded on a recording medium by discharging ink droplets from the nozzles while the recording medium is relatively moved with respect to the inkjet recording head.

9. An inkjet recording apparatus wherein the liquid discharge head of claim 4 is used as an inkjet recording head, and images are recorded on a recording medium by discharging ink droplets from the nozzles while the recording medium is relatively moved with respect to the inkjet recording head.

10. An inkjet recording apparatus wherein the liquid discharge head of claim 5 is used as an inkjet recording head, and images are recorded on a recording medium by discharging ink droplets from the nozzles while the recording medium is relatively moved with respect to the inkjet recording head.
